(19) United States
(12) Patent Application Publication
(10) Pub. No.: US 2006/0170421 A1
(43) Pub. Date: Aug. 3, 2006

(54) Moving-target magnetic resonance imaging system and method

(75) Inventors: Mark G. Benz, Lincoln, VT (US); Matthew W. Benz, Shrewsbury, MA (US)

Correspondence Address: DOWNS RACHLIN MARTIN PLLC, 199 MAIN STREET, P O BOX 190, BURLINGTON, VT, 05402-0190, US

(73) Assignee: Pediatric Imaging Technology, LLC, Lincoln, VT (US)

(21) Appl. No.: 11/168,083

(22) Filed: Jun. 27, 2005

Related U.S. Application Data
(60) Provisional application No. 60/583,500, filed on Jun. 28, 2004.

(51) Int. Cl. G01V 3/00

(52) U.S. Cl. 324/309; 324/318

(57) ABSTRACT

A system and method for imaging an object that takes into account movement of the object in producing an MR image. A system may include a target volume location sensor for determining a location of an object being imaged. A moving-target algorithm may use the location information and other image information to match appropriate data to construct an image of the object. A moving-target algorithm may use the location information to provide instruction on changing a gradient field of an imaging system to account for a location of an object.

### RELATED APPLICATION DATA

This application claims the benefit of priority of U.S. Provisional Patent Application Ser. No. 60/583,500, filed Jun. 28, 2004, and titled “Moving-Target System for MR”, which is incorporated by reference herein in its entirety.

### FIELD OF THE INVENTION

The present invention generally relates to the field of magnetic resonance (MR) imaging. In particular, the present invention is directed to a moving-target MR imaging system and method.

### BACKGROUND OF THE INVENTION

Magnetic resonance has been used for many years as an imaging technique. One area that has benefited from MR imaging is medical imaging. MR imaging provides a technique to the medical field that does not involve harmful ionizing radiation. Instead, MR imaging involves applying appropriate magnetic fields to an object to be imaged. Radio frequency (RF) energy is then provided to the object. Spatial variations in the phase and frequency of the RF energy that is absorbed and emitted by the imaged object is used to produce an image. Typically, it is the absorption and re-emission of the RF energy by hydrogen nuclei (¹H) in the object being imaged that is observed. However, different nuclei can also be observed. The resonant frequency of this absorption and re-emission is given by the relationship: F=γ B₀, where F=resonant frequency typically given in MegaHertz (MHz), B₀=magnetic field typically given in Tesla (T), γ=gyromagnetic ratio=42.577 MHz/T for ¹H.

MR imaging generates images using time-dependent variations in emission intensity as a function of frequency. Frequency is also used to encode spatial address information to the many spatial segments (volume elements) of an object being imaged. Variations in local magnetic fields are purposely created to give a discrete and slightly different magnetic field (and hence different resonant frequency) for each volume element in the field of view. Variations in the local magnetic field caused by variations in molecular structure are typically ignored. However, shifts due to differences in the molecular structure of water and fat are sometimes accounted for in MR. Examples of applied magnetic fields include about 0.5 T to about 1.5 T when provided by an electromagnetic structure using a superconducting winding, and about 0.2 T to about 0.5 T when provided by a permanent magnet structure.

Each scan of a volume can take as little as a fraction of a second to complete. Random noise can be identified and removed from scans by performing repetitive scans, usually taken over a multiple minute period of time. During the repetitive scans the object is required to remain stationary. Algorithms used by MR imaging systems assume that the target object remains stationary and that no spatial movement of the target's volume elements has occurred between the repetitive scans. This stationary requirement creates complications when the object is unable, or unwilling, to remain stationary during the repetitive scans. Examples of such objects include, but are not limited to, a child; an infant; a patient with diminished ability to follow directions; a patient with tremors, such as occur with Parkinson's Disease; a trauma patient where movement is likely; a patient where sedation is not possible; and an animal. To bring such objects into compliance with the no-movement assumption, sedation is often used. However, sedation limits the ease with which observations can be scheduled and carries the risk of sedation-related complications.

Various “fast-scan” MRI techniques under development address minor movements and motion artifacts resulting from physiological processes (i.e., cardiac and respiratory movements). These techniques do not allow for significant gross movement (i.e., the “wiggle factor”) among patients.

Finding a sedation-free MR solution is particularly important in pediatric medical imaging where MR serves as a safe alternative to x-ray computer tomography (CT) and other ionizing radiation imaging techniques. Ionizing radiation, such as x-ray and gamma radiation, has been used for years in imaging systems, particularly in medical imaging. Exposure to ionizing radiation has many documented harmful effects, one of the most serious of which is the induction of fatal cancers. All human suspects are susceptible to ionizing radiation in the doses provided by typical imaging technology. However, children and infants are reported to be at approximately ten times greater risk than an average middle-aged adult. This increased susceptibility to the negative effects of ionizing radiation is due in part to the developing and dividing cells of a child's body, which are more susceptible to radiation-induced neoplastic transformation than the cells of an adult. Additionally, children have a greater lifespan remaining than a middle-aged adult for the genotoxic effects of the radiation to manifest. Conventional x-ray CT technology doses have been found to be similar to the doses that were received by World War II Japanese atomic bomb survivors, a group in whom excess cancer mortality has been observed. Using data from such survivors, Brenner et al. has predicted that the use of conventional x-ray CT technology on infants and children may cause the eventual cancer-related death of 1 out of every 1000 children examined using such CT technology. See Brenner et al., “Estimated risks of radiation-induced fatal cancer from pediatric CT,” AJR Am J Roentgenol. 2001;176:289-296. This rate is considered by many to be unacceptably high. As an example, of the approximately 12 million infants and children that have been imaged by CT in the United States since the observations by Brenner et al. in 2001, approximately 12,000 are expected to die later in life from cancer initiated by the CT procedure.

New MR imaging systems and methods are needed to allow for target object movement during imaging.

### SUMMARY OF THE INVENTION

In one embodiment, the present invention provides a system for imaging a target volume element using a magnetic field defined by at least one magnet volume element. Each of the at least one magnet volume elements has a corresponding magnet volume signal including content data representing an object positioned in the at least one magnet volume element. The system includes a target volume location device for providing a first signal that varies with changes in location of the target volume element with respect to the at least one magnet volume element. The system also includes a moving-target algorithm for using the location to correlate the target volume element to a corresponding content data.

In another embodiment, the present invention provides an MR imaging system for imaging a target volume. The system includes a first device for MR imaging. The first device generates a magnetic field having one or more magnet volume elements. The first device being for determining a content data representing a portion of the target volume positioned in each of the one or more magnet volume elements. The system also includes a target volume location device in communication with the first device, the target volume location device being for determining a location of a target volume element of the target volume and to communicate the location to the first device.

In yet another embodiment, the present invention provides an imaging system for imaging a target volume element using a magnet device that produces a magnetic signal defined by at least one magnet volume element, the at least one magnet volume element having an associated magnet volume signal. The system includes a target volume location device that provides a first signal which varies with changes in location of the target volume element with respect to the at least one magnet volume element. The system also includes a controller operatively configured to use the first signal to correlate the magnet volume signal with the target volume element to produce an MR output signal.

In still another embodiment, the present invention provides an imaging system for producing an image of a target volume element. The system includes an MR imaging device for providing a plurality of scans of a magnetic field to the target volume element, the magnetic field defined by at least one magnet volume element, the at least one magnet volume element having an associated magnet volume signal for each of the plurality of scans. The system also includes a moving-target algorithm for using variation in the magnet volume signal over the plurality of scans to determine a location of the target volume element, the moving-target algorithm using the location to match the target volume element to a corresponding magnet volume signal to produce an MR output.

In still yet another embodiment, the present invention provides a method of producing an MR image. The method includes (a) producing a magnetic field defined by at least one magnet volume element; (b) providing a target volume element; (c) measuring a location of the target volume element relative to the at least one magnet volume element; (d) generating positional information about the location; (e) determining a magnet volume signal including content data representative of the at least one magnet volume elements; (f) correlating the magnet volume signal to the target volume element using the positional information; and (g) producing an MR image.

In a further embodiment, the present invention provides a method of producing an MR image. The method includes (a) producing a magnetic field defined by at least one magnet volume element; (b) providing a target volume element; (c) measuring a plurality of magnet volume signals, the plurality of magnet volume signals being measured over a plurality of scans of an RF element, each of the plurality of magnet volume signals including content data representative of the at least one magnet volume elements; (d) using variations in the content data across the plurality of magnet volume signals to determine positional information representing a location of the target volume element; (e) correlating the magnet volume signal to the target volume element using the positional information; and (f) producing an MR image.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 shows one example of an imaging system according to the present invention;

FIG. 2A shows one example of a magnet volume with magnet volume elements;

FIG. 2B shows one example of a target volume with target volume elements;

FIG. 3 shows another example of an imaging system according to the present invention;

FIG. 4 shows yet another example of an imaging system according to the present invention; and

FIG. 5 shows still another example of an imaging system according to the present invention.

### DETAILED DESCRIPTION

The present invention provides a system and method that allows and/or corrects for motion by a target object during imaging by using a motion sensing device to track the movement of the target object with respect to the magnetic field. The location information can be used to correct for the movement and produce a more accurate image.

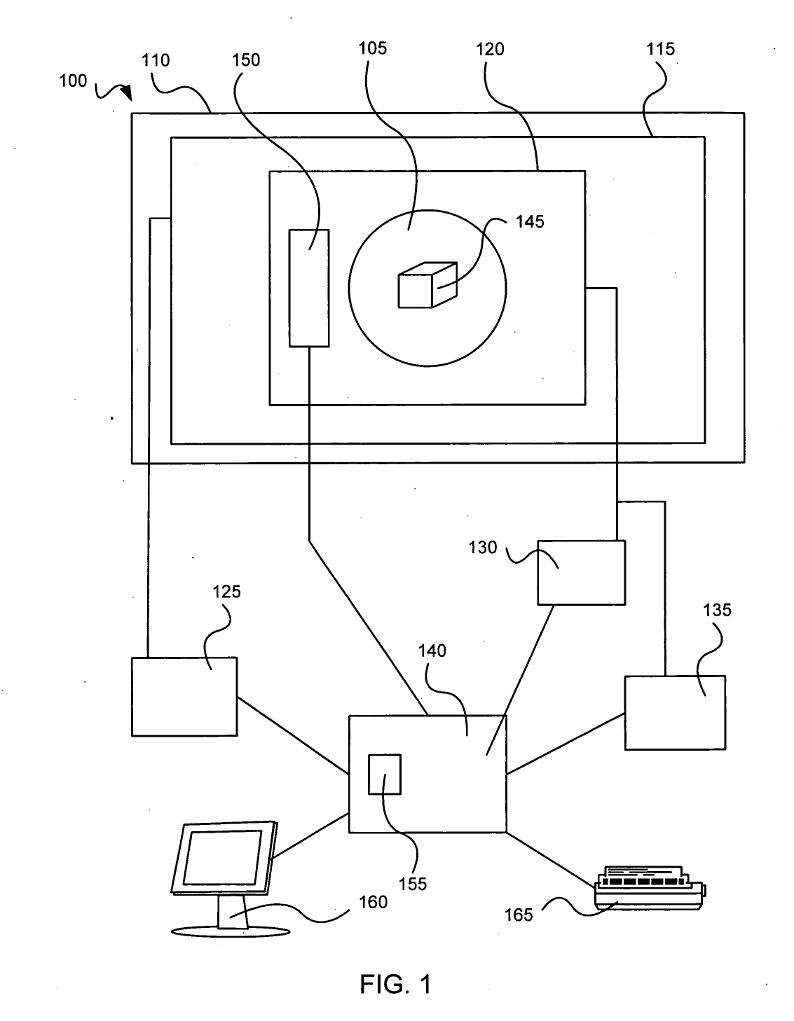

FIG. 1 shows an exemplary embodiment of the present invention. Imaging system 100 includes an imaging compartment 105. An object to be imaged can be placed in imaging compartment 105. System 100 also includes a constant-field magnet 110, a gradient-field magnet 115, and an RF element 120. Various magnets, RF elements, and their controls for use in MR imaging are known to those of ordinary skill. Example constant-field magnets include, but are not limited to, superconducting, resistive, permanent, and any combinations thereof. One example of a constant-field magnet includes a superconducting magnet system that produces magnetic fields in the range of about 0.2 T to about 1.5 T. Gradient-field magnet 115 is in communication with a gradient-source element 125. In one example, gradient-field magnet 115 includes coils configured to produce a desired gradient in Bₒ. An example gradient coil configuration produces gradients in the x, y, and z coordinate axes by using an antihelmholtz type coil for the gradient in Bₒ in the z direction, a FIG. 8 coil for the gradient in Bₒ in the y direction, and a FIG. 8 coil for the gradient in Bₒ in the x direction. Coordinate axes other than the x, y, z system and gradient-field systems to create unique field addresses within them are also contemplated. In another example, a gradient-field magnet is driven by a pulse sequence, the shape, duration and magnitude of which may be controlled by a controller, such as general computing device 140. The gradients are used by system 100 to provide a unique local field address to each volume segment of the Bₒ magnetic field.

RF element 120 is in communication with an RF receiving element 130 and an RF source 135. In one example, RF element 120 may be a single transmit and receive device and/or coil. In another example, RF element 120 may include a separate transmit device and/or coil and a separate receive device and/or coil. Gradient-source element 125, RF receiver 130, and RF source 135 are in communication with a general computing device 140. General computing device 140 may be used to control gradient-source element 125, RF source 135, and other parts of the system. General computing device 140 may be a single general computing device or may include a plurality of general computing devices.

Constant-field magnet 110 produces a constant magnetic field, Bₒ, for polarizing the nuclei (typically ¹H) of object 145 in the field of view of imaging compartment 105. Gradient-source element 125 drives gradient-field magnet 115 to produce gradients in Bₒ.

RF source 135 drives RF element 120 to provide an RF energy to the nuclei of object 145. RF receiver 130 receives signals from RF element 120 representing re-emitted energy from the nuclei of object 145 and communicates information related to those signals to general computing device 140. The shape, duration, and magnitude of an RF signal may be controlled by a controller, such as general computing device 140.

System 100 also includes a target volume location sensor 150 for sensing the position of object 145. Target volume location sensor 150 may include any motion sensing device that can detect the position of a target volume element of object 145 within the field of view of system 100. Various location sensing devices are known to those of ordinary skill. Example location sensing devices include, but are not limited to, an optical sensor, a sonic sensor, an ultra-sonic sensor, an electromagnetic tracking device, an MR device, and any combinations thereof. Target volume location sensor 150 is in communication with general computing device 140. Target volume location sensor 150 provides general computing device 140 with information related to the position of object 145. General computing device 140 uses this information and the information related to the RF signals received from RF receiver 130 to produce an image output that accounts for motion of object 145. General computing device 140 may utilize a moving-target algorithm 155 to produce the image.

General computing device 140 is in communication with an input/output console 160 and an output device 165. A user of system 100 may utilize input/output console 160 to control the various components of system 100 and to view an image produced. The image may also be provided to output device 165. Example output devices 165 include, but are not limited to, a printer; a display device; a storage device, such as a hard-drive, flash memory, or optical disk; and any combinations thereof.

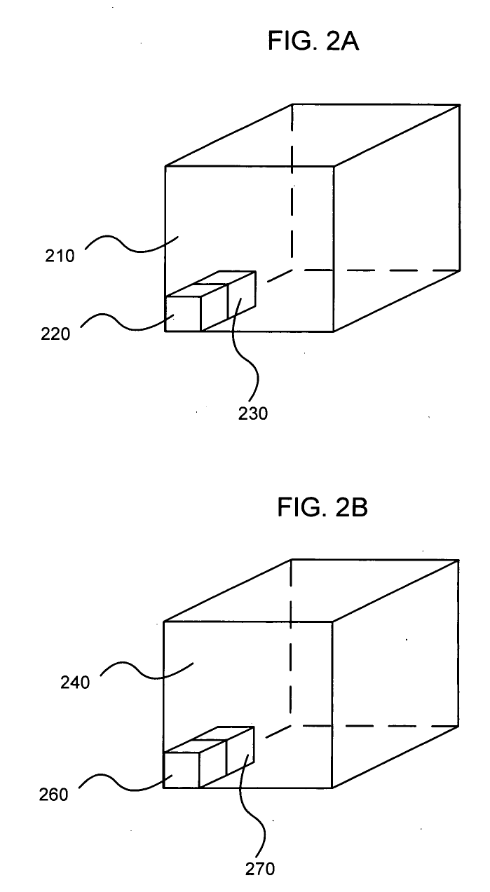

FIG. 2A illustrates an example of a magnet volume 210 representing a volume of a magnetic field, Bₒ, produced by an MR system according to the present invention. Magnet volume 210 may be the entire field of view of a system or only a portion thereof. Magnet volume 210 is divided into magnet volume elements, shown for example by magnet volume element 220 and magnet volume element 230. Although, the magnet volume elements of this example are shown as cubical, other shaped volume elements are contemplated. The size of a volume element may vary depending on the gradient field applied to the constant magnetic field. In one example, a magnet volume element has a size of about 3 cubic millimeters (mm³).

Magnet volume 210 would be subjected to constant-field, Bₒ. A gradient field may be produced that modifies the local magnetic field of each of the magnet volume elements. For example, magnet volume element 220 may have a local magnetic field, Bₐ, and magnet volume element 230 may have a local magnetic field, B_{b}.

FIG. 2B illustrates an example of a target volume 240 of an object, or a portion of an object, positioned in the same space as magnet volume 210. Target volume 240 is divided into target volume elements, shown for example by target volume element 260 and target volume element 270. At a first point in time, target volume element 260 may align with magnet volume element 220 and be subjected to a local magnetic field, Bₐ. When an RF pulse is generated by RF element 120, an RF energy is absorbed and re-emitted by nuclei of target volume element 260, the RF signal received by an RF element and RF receiver, such as RF receiver 130, includes one or more frequencies that correspond to information related to the contents of target volume element 260 and unique address information for magnet volume element 220. This information may be referred to as a magnet volume signal. In one example, a magnet volume signal may be delivered from an RF receiver, such as RF receiver 130, in combination with other magnet volume signals representing other magnet volume elements. In such a situation a controller, such as general computing device 140, may interpret the mixed information in a variety of ways, including simultaneously or individually after parsing amongst magnet volume elements.

In one aspect, content data related to a particular magnet volume element, such as magnet volume element 220, may be referred to as a voxel. A voxel may be reconstructed by a controller to represent one or more pixels of an MR image.

At this same point in time, target volume element 270 may align with magnet volume element 230 and be subjected to a local magnetic field, B_{b}. The magnet volume signal for target volume element 270, in this case, would include information related to the contents of target volume element 270 and unique address information for magnet volume element 220. A controller, such as general computing device 140 of FIG. 1, may use the two magnet volume signals (and magnet volume signals for the magnet volume elements not explicitly shown in FIG. 2) to produce an image representing the object. However, a single scan image may suffer from noise. In order to reduce noise, repetitive scans can be taken and information from each corresponding magnet volume signal may be combined to form an image.

In this example, if target volume 240 were to move in relation to magnet volume element 210 (assuming no change in the gradient field), the information from subsequent scans would not match with the previous unique address information for the magnet volume elements. For example, target volume element 260 may move in position from magnet volume element 220 to magnet volume element 230. In doing so, target volume element 260 is now subjected to a different local magnetic field, B_{b}, than it was during the previous scan when it was subjected to Bₐ and, thus, has a different unique address information than in the previous scan. Table 1 summarizes the impact this movement has on the information used to produce an image.

Table 1 shows that at the time of a first scan, t₁, target volume element 260 (TVE₁) is positioned in the space of magnet volume element 220 (MVE₁) and is subjected to Bₐ. At the same time, as discussed above, target volume element 270 (TVE₂) is positioned in the space of magnet volume element 230 (MVE₂) and is subjected to B_{b}. A first magnet volume signal corresponding to MVE₁ would include information about the content of TVE₁. A second magnet volume signal corresponding to MVE₂ would include information about the content of TVE₂. Upon a second scan at t₂, TVE, has physically moved to MVE₂ and is now subjected to B_{b}. The first magnet volume signal for this scan has no information related to the object. The second magnet volume signal for T₂ now includes information about the content of TVE₁. If a controller attempts to combine information from the two second magnet volume signals, the resulting image signal will be inaccurate as attempting to display TVE₂ and TVE₁ in the same location.

TABLE 1

| | Position of | Local | Data Content of | Data Content of |
|---|---|---|---|---|
| | Target Volume | Magnetic | First Magnet | Second Magnet |
| Scan | Element, TVE₁ | Field | Volume Signal | Volume Signal |
| t₁ | MVE₁ | Bₐ | TVE₁ | TVE₂ |
| t₂ | MVE₂ | B_{b} | — | TVE₁ |

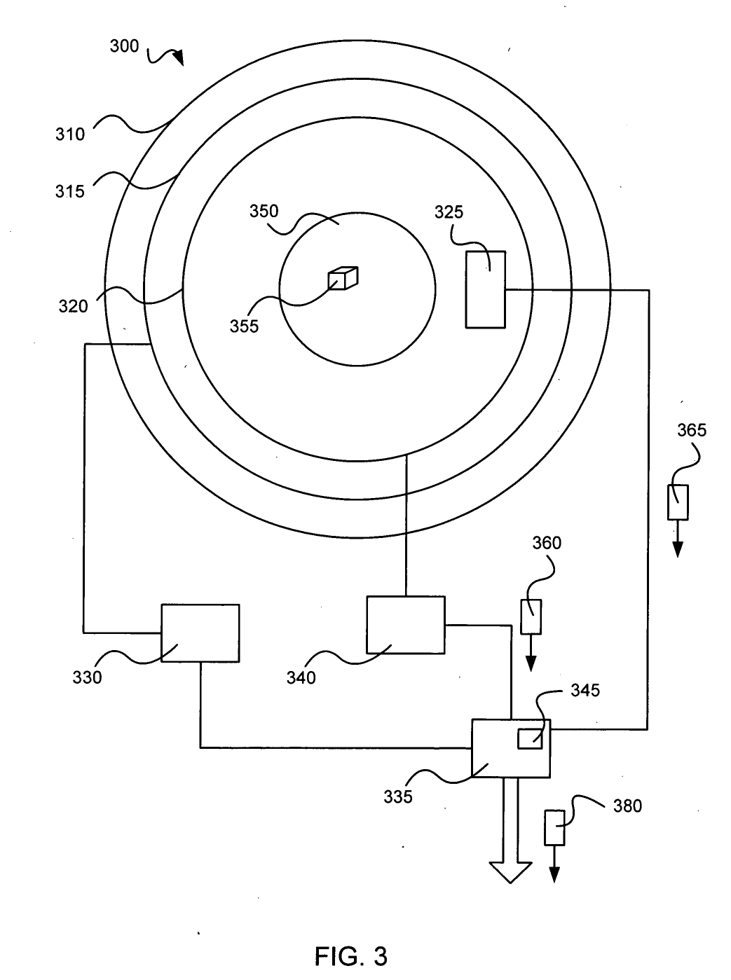

FIG. 3 illustrates another embodiment of the present invention. System 300 includes a constant-field device 310, a gradient-field device 315, an RF device 320, and a target volume location device 325. Gradient-field device 315 is in communication with a gradient-field power supply 330, which is in communication with a controller 335. RF device 320 is in communication with an RF send/receive system 340, which is in communication with controller 335. Target volume location device 325 is in communication with controller 335. Controller 335 includes a moving-target algorithm 345. An object 350 may be positioned to be imaged by system 300. Object 350 includes a target volume element 355. Constant-field device 310 produces a constant magnetic field, Bₒ, having a first magnetic volume element. Gradient-field device 315, driven by gradient-field power supply 330, produces a gradient field across Bₒ giving the first magnetic volume element a unique local magnetic field. RF send/receive system 340 drives RF device 320 to provide a first RF signal to target volume element 355. Target volume element 355 is located during this first RF signal in the same space as the first magnet volume element. RF device 320 receives a first RF signal emitted from nuclei within target volume element 355 and communicates data signal 360 (magnet volume signal) having information related to the content of the first magnet volume element and the location of the first magnet volume element via RF send/receive system 340 to controller 335. Target volume location device 325 determines the location of target volume element 355 and communicates location signal 365 including information related to this location to controller 335. This process is repeated for a desired number of repetitive scans even as target volume element 355 moves from first magnet volume element to a different magnet volume element. Each repetitive scan produces a corresponding data signal 360 having information related to the content of each magnet volume element identified by its own unique address information, and produces a corresponding location signal 365 including information related to the then-current location of target volume element 355 with respect to the magnet volume elements. Controller 335 uses moving-target algorithm 345 and the various location signals to correlate the content information from each data signal to the proper magnet volume element.

A moving-target algorithm, such as moving-target algorithm 345, includes any algorithm that can utilize the location information of the position of an object, as provided, e.g., by target volume location device 325, to correlate the proper target volume element to the correct magnet volume element. One of ordinary skill will recognize a variety of ways to construct an algorithm to use the location information in this manner. One example of a moving-target algorithm is a target-volume-tracking algorithm. A target-volume-tracking-algorithm uses location information for one or more target volume elements of an object to establish a mathematical relationship between magnet volume elements and target volume elements to allow reconstruction of an image related to the target volume elements. Another example of a moving-target algorithm is a gradient-field adjusting algorithm. A gradient-field-adjusting algorithm uses location information for one or more target volume elements of an object to adjust drive currents of a gradient-field system to provide the correct unique local field address (magnetic field) to the appropriate magnet volume element as the target volume element moves from one magnet volume element to another.

With continuing reference to FIG. 3, controller 335 produces an image output signal 380 using a target-volume-tracking algorithm 345, location signals 365, and data signals 360. An image output signal can be managed as necessary. Ways to manage an image output signal include, but are not limited to, display, storage, transfer, printing, and any combinations thereof.

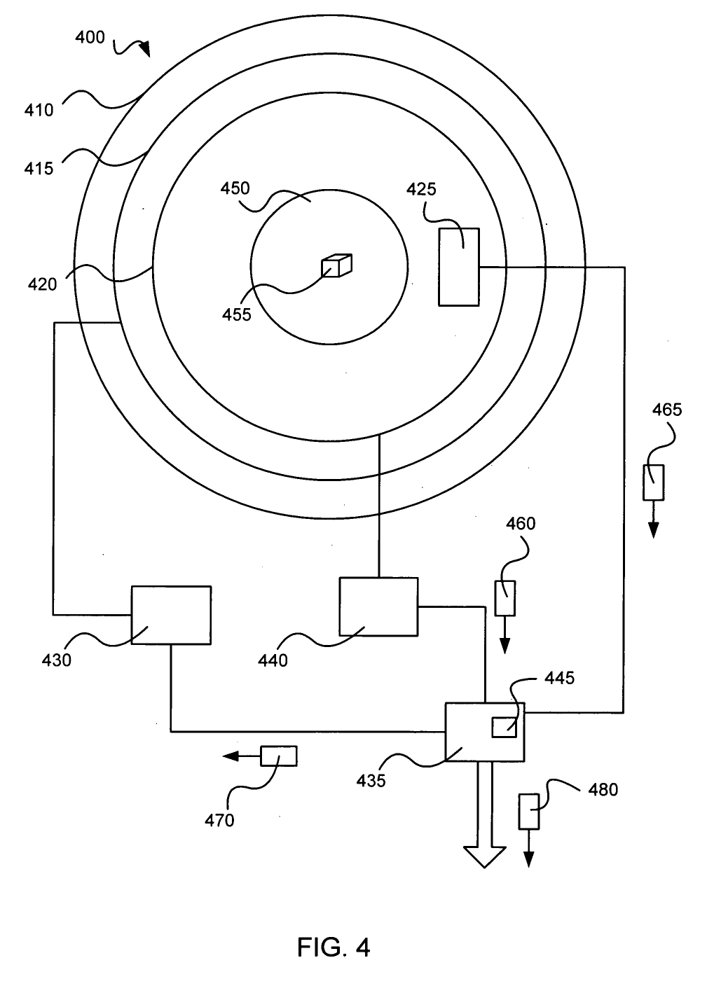

FIG. 4 illustrates yet another embodiment of the present invention. System 400 includes a constant-field device 410, a gradient-field device 415, an RF device 420, and a target volume location device 425. Gradient-field device 415 is in communication with a gradient-field power supply 430, which is in communication with a controller 435. RF device 420 is in communication with an RF send/receive system 440, which is in communication with controller 435. Target volume location device 425 is in communication with controller 435. Controller 435 includes a moving-target algorithm 445. An object 450 may be positioned to be imaged by system 400. Object 450 includes a target volume element 455. Constant-field device 410 produces a constant magnetic field, Bₒ, having a first magnetic volume element. Gradient-field device 415, driven by gradient-field power supply 430, produces a gradient field across Bₒ giving the first magnetic volume element a unique local magnetic field. RF send/receive system 440 drives RF device 420 to provide a first RF signal to target volume element 455. Target volume element 455 is located during this first RF signal in the same space as the first magnet volume element. RF device 420 receives an RF signal emitted from nuclei within target volume element 455 and communicates data signal 460 having information related to the content of the first magnet volume element and the location of the first magnet volume element via RF send/receive system 440 to controller 435. Target volume location device 425 determines the location of target volume element 455 and communicates location signal 465 including information related to this location to controller 435. In successive scans, successive target location signals 465 are used by controller 435 and moving-target algorithm 445 (here, a gradient-field-adjusting algorithm) to modify the gradient field with signal 470 to have a single appropriate unique local address follow target volume element 455 as it moves from one magnet volume element to another. This involves reassigning a particular local magnetic field to a magnet volume element then currently having the same space as target volume element 455. As repetitive scans occur, the corresponding data signal 460 will have the appropriate content data for target volume element 455 assigned to consistent addressing information. Controller 435 may then produce an image output signal 480 from the consistent data. In one example, gradient-field device 415 includes a gradient coil. In this example, moving-target algorithm 445 may provide instruction to gradient-field power supply 430 to modify current to the gradient coil in a manner that modifies the gradient of Bₒ to account for movement by object 450. Some gradient coils have inductance that makes rapid change in applied field difficult. In such a situation controller 435 and/or moving-target algorithm 445 may include in the instructions to gradient-field power supply 430 an instruction to overdrive the current provided to the gradient coil at the beginning of a gradient change and bringing the current back to a nominal current value for the remainder of a pulse.

In still another embodiment, a controller, such as controller 435 can include both a gradient-field-adjusting algorithm and a target-volume-tracking algorithm. In such an embodiment, the controller can utilize location information from a target volume location device to modify the gradient field as in the above embodiment. The controller can also use the location information to further correlate content information in received data signals by establishing the mathematical relationship between one or more magnet volume elements and one or more target volume elements. This can further ensure that the appropriate content data for the correct target volume element is assigned to a particular magnet volume element prior to image creation.

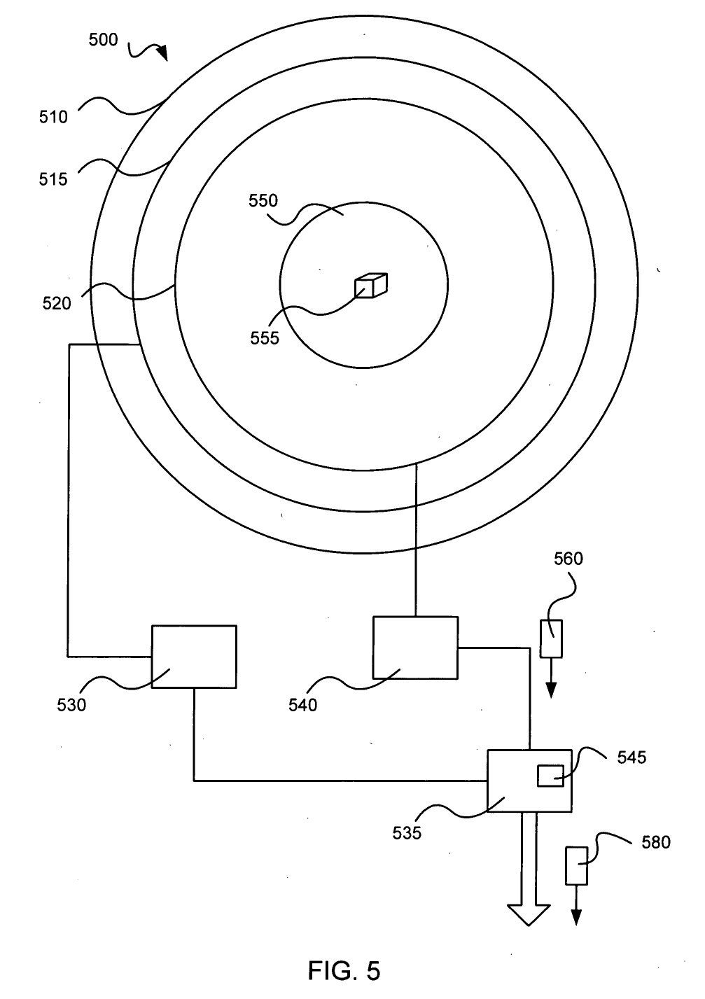

FIG. 5 illustrates a further embodiment of the present invention. System 500 includes a constant-field device 510, a gradient-field device 515, and an RF device 520. Gradient-field device 515 is in communication with a gradient-field power supply 530, which is in communication with a controller 535. RF device 520 is in communication with an RF send/receive system 540, which is in communication with controller 535. Controller 535 includes a moving-target algorithm 545. An object 550 may be positioned to be imaged by system 500. Object 550 includes a target volume element 555. Constant-field device 510 produces a constant magnetic field, Bₒ, having a first magnetic volume element. Gradient-field device 515, driven by gradient-field power supply 530, produces a gradient field across Bₒ giving the first magnetic volume element a unique local magnetic field. RF send/receive system 540 drives RF device 520 to provide a first RF signal to target volume element 555. Target volume element 555 is located during this first RF signal in the same space as the first magnet volume element. RF device 520 receives an RF signal emitted from nuclei within target volume element 555 and communicates data signal 560 having information related to the content of the first magnet volume element and the location of the first magnet volume element via RF send/receive system 540 to controller 535. Controller 535 uses variations in successive data signals 560 from successive scans of target volume element 555 to determine the actual location of target volume element 555. Controller 535 then uses moving-target algorithm 545 and this location information to correlate target volume element 555 to the appropriate magnet volume element to produce an MR image output 580. In one example of this embodiment, moving-target algorithm 545 may include a gradient-field-adjusting algorithm, a target-volume-tracking algorithm, or both.

In yet a further embodiment of the present invention, an existing MR system may be modified to allow for movement by an object to be imaged. In one example, an existing MR system may be retrofitted with a target volume location sensor, e.g., sensor 150, according to the present invention. The target volume location sensor may be connected to an existing controller (or new controller), which is provided an appropriate moving-target algorithm.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for imaging a target-volume element using a magnetic field defined by at least one magnet-volume element, each of said at least one magnet-volume elements having a corresponding magnet-volume signal including content data representing an object positioned in said at least one magnet-volume element, the system comprising:
(a) a target-volume-location device for providing a first signal containing information that varies with changes in location of the target volume element with respect to the at least one magnet-volume element; and
(b) a moving-target algorithm for using said information to correlate the target-volume element to a corresponding content data.

2. A system according to claim 1, wherein said moving-target algorithm includes an algorithm selected from the group consisting of a target-volume-tracking algorithm, a gradient-field-adjusting algorithm, and any combination thereof.

3. A system according to claim 1, wherein the system provides a MR output signal based on said corresponding content data.

4. A system according to claim 3, wherein said MR output signal comprises an MR image representing the target-volume element.

5. An MR imaging system for imaging a target volume, the system comprising:
(a) a first device for MR imaging, said first device generating a magnetic field having one or more magnet-volume elements, said first device for determining a content data representing a portion of the target volume positioned in each of said one or more magnet-volume elements; and
(b) a target-volume-location device in communication with said first device, wherein said target-volume-location device determines a location of a target-volume element of the target volume and communicates said location to said first device.

6. A system according to claim 5, further comprising a controller in communication with said first device and said target-volume-location device, said controller for controlling said first device and receiving said content data and said location.

7. A system according to claim 6, wherein said controller comprises a target-volume-tracking algorithm for using said location to match said target-volume element to a corresponding content data.

8. A system according to claim 6, wherein said controller comprises a gradient-field-adjusting algorithm for modifying said magnetic field in response to said location.

9. A system according to claim 6, further comprising an output device in communication with said controller, said output device for receiving an image from said controller, said image representing said target-volume element.

10. A system according to claim 7, wherein said controller comprises a gradient-field-adjusting algorithm for modifying said magnetic field in response to said location.

11. A system according to claim 5, wherein said target-volume-location device uses MR technology to determine the position of said target-volume element.

12. An imaging system for imaging a target-volume element using a magnet device that produces a magnetic signal defined by at least one magnet-volume element, said at least one magnet-volume element having an associated magnet-volume signal, said imaging system comprising:
(a) a target-volume-location device that provides a first signal with information that varies with changes in location of said target-volume element with respect to said at least one magnet-volume element; and
(b) a controller operatively configured to use said first signal to correlate the magnet-volume signal with said target volume element to produce an MR output signal.

13. A system according to claim 12, wherein said MR output signal comprises an MR image.

14. A system according to claim 12, wherein said motion sensing device uses MR technology to determine the position of said target-volume element.

15. A system according to claim 12, wherein said controller comprises a target-volume-tracking algorithm for correlating the magnet-volume signal with said target-volume element.

16. A system according to claim 12, wherein said controller comprises a gradient-field-adjusting algorithm for modifying the magnetic signal in response to said first signal.

17. A system according to claim 15, wherein said controller comprises a gradient-field-adjusting algorithm for modifying the magnetic signal in response to said first signal.

18. An imaging system for producing an image of a target-volume element, the system comprising:
(a) an MR imaging device for providing a plurality of scans of a magnetic field to the target-volume element, said magnetic field defined by at least one magnet-volume element, said at least one magnet-volume element having an associated magnet-volume signal for each of said plurality of scans; and
(b) a moving-target algorithm for using variation in said magnet-volume signal over said plurality of scans to determine a location of the target-volume element, said moving-target algorithm using said location to match the target-volume element to a corresponding magnet-volume signal to produce an MR output.

19. A system according to claim 18, wherein said moving-target algorithm includes an algorithm selected from the group consisting of a target-volume-tracking algorithm, a gradient-field-adjusting algorithm, and any combination thereof.

20. A system according to claim 18, wherein said MR output comprises an MR image representing the target-volume element.

21. A method of producing an MR image, the method comprising:
(a) producing a magnetic field defined by at least one magnet-volume element;
(b) providing a target-volume element;
(c) measuring a location of said target-volume element relative to said at least one magnet-volume element;
(d) generating positional information about said location;
(e) determining a magnet-volume signal including content data representative of said at least one magnet-volume elements;
(f) correlating said magnet-volume signal to said target volume element using said positional information; and
(g) producing an MR image.

22. A method according to claim 21, wherein said measuring step is conducted by a motion-sensing device.

23. A method according to claim 22, wherein said motion-sensing device uses MR technology to determine the position of said target-volume element.

24. A method according to claim 21, wherein said correlating step includes using a target-volume-tracking algorithm to match said target-volume element with a corresponding magnet-volume signal.

25. A method according to claim 21, wherein said correlating step includes using a gradient-field-adjusting algorithm to modify said magnetic field to match said positional information with a corresponding magnet volume element.

26. A method according to claim 24, wherein said correlating step further comprises using a gradient-field-adjusting algorithm to modify said magnetic field to match said positional information with a corresponding magnet-volume element.

27. A method of producing an MR image, the method comprising:
(a) producing a magnetic field defined by at least one magnet-volume element;
(b) providing a target-volume element;
(c) measuring a plurality of magnet-volume signals, said plurality of magnet-volume signals being measured over a plurality of scans of an RF element, each of said plurality of magnet-volume signals including content data representative of said at least one magnet-volume elements;
(d) using variations in said content data across said plurality of magnet-volume signals to determine positional information representing a location of said target-volume element;
(e) correlating said magnet-volume signal to said target-volume element using said positional information; and
(f) producing an MR image.

28. A method according to claim 27, wherein said measuring step is conducted using a motion sensing device.

29. A method according to claim 28, wherein said motion sensing device uses MR technology to determine the position of said target volume element.

30. A method according to claim 27, wherein said correlating step includes using a target-volume-tracking algorithm to match said target-volume element with a corresponding magnet-volume signal.

31. A method according to claim 27, wherein said correlating step includes using a gradient-field-adjusting algorithm to modify said magnetic field to match said positional information with a corresponding magnet-volume element.

32. A method according to claim 30, wherein said correlating step further comprises using a gradient-field-adjusting algorithm to modify said magnetic field to match said positional information with a corresponding magnet-volume element.
